(19) United States
(12) Patent Application Publication
(10) Pub. No.: US 2016/0309373 A1
(43) Pub. Date: Oct. 20, 2016

(54) CHARGING INTERFACE FOR INTER-RADIO ACCESS TECHNOLOGY HANDOVER OF CALL SESSIONS

(71) Applicant: Alcatel-Lucent USA Inc., Murray Hill, NJ (US)

(72) Inventors: Mohammad R. Khawer, Lake Hopatcong, NJ (US); Yigang Cai, Naperville, IL (US)

(21) Appl. No.: 14/686,066

(22) Filed: Apr. 14, 2015

(51) Int. Cl. H04W 36/00

(52) U.S. Cl. CPC H04W 36/0022

(57) ABSTRACT

A charging session identifier is transmitted over an interface between a first base station and a second base station in response to initiation of a handover of a call session between the first and second base stations. The first and second base stations operate according to different radio access technologies. The first base station transmits first charging information collected by the first base station for the call session and second charging information collected by the second base station for the call session to a network charging system using the identifier.

### CROSS REFERENCE TO RELATED APPLICATIONS

This application is related to U.S. patent application Ser. No. 14/576,405 (Attorney Docket No. 817438), entitled “LTE SMALL CELL HANDOVER TO CARRIER GRADE WI-FI” and filed on Dec. 19, 2014, the entirety of which is incorporated by reference herein.

### BACKGROUND

1. Field of the Disclosure

The present disclosure relates generally to wireless communication systems and, more particularly, for providing charging information in wireless communication systems.

2. Description of the Related Art

The demand for mobile wireless data has been growing at an exponential rate and is expected to continue to grow by many orders of magnitude in the coming years. Meeting the increasing demand will require a corresponding increase in the amount of spectrum available for wireless communication. The spectrum available for uplink or downlink communications with user equipment includes licensed frequency bands and unlicensed frequency bands. Unlicensed frequency bands are portions of the radiofrequency spectrum that do not require a license for use and may therefore be used by any device to transmit or receive radio frequency signals. For example, the Unlicensed National Information Infrastructure (UNII) is formed of portions of the radio spectrum that include frequency bands in the range of 5.15 GHz to 5.825 GHz such as the U-NII-1 band in the range 5.15-5.25 GHz, the U-NII 2a, b, c bands in the range 5.25-5.725 GHz, and the U-NII3 band in the range 5.725-5.825 GHz. Unlicensed frequency bands can be contrasted to licensed frequency bands that are licensed to a particular service provider and may only be used for wireless communication that is authorized by the service provider.

### SUMMARY OF EMBODIMENTS

The following presents a summary of the disclosed subject matter in order to provide a basic understanding of some aspects of the disclosed subject matter. This summary is not an exhaustive overview of the disclosed subject matter. It is not intended to identify key or critical elements of the disclosed subject matter or to delineate the scope of the disclosed subject matter. Its sole purpose is to present some concepts in a simplified form as a prelude to the more detailed description that is discussed later.

In some embodiments, a method is provided for conveying charging information over a charging interface for inter-radio access technology (inter-RAT) handover of a call session. The method includes transmitting an identifier over an interface between a first base station and a second base station in response to initiation of a handover of a call session between the first and second base stations. The first and second base stations operate according to different radio access technologies. The method also includes transmitting, from the first base station to a network charging system, first charging information collected by the first base station for the call session and second charging information collected by the second base station for the call session using the identifier.

In some embodiments, a method is provided for aggregating charging information received over a charging interface for inter-radio access technology (inter-RAT) handover of a call session. The method includes receiving, at a first base station in response to initiation of a handover of a call session between the first base station and a second base station, an identifier and second charging information collected by the second base station for the call session. The identifier and the second charging information are transmitted over an interface between the first and second base stations. The first and second base stations operate according to different radio access technologies. The method also includes transmitting, from the first base station to a network charging system, first charging information collected by the first base station for the call session and the second charging information using the identifier.

In some embodiments, a method is provided for transmitting charging information received over a charging interface for inter-radio access technology (inter-RAT) handover of a call session. The method includes collecting, at a first base station, first charging information for a call session. The method also includes transmitting, from the first base station over an interface between the first base station and a second base station, an identifier and the first charging information in response to initiation of a handover of the call session between the first and second base stations. The first and second base stations operate according to different radio access technologies. The identifier is used to transmit the first charging information and second charging information collected by the second base station for the call session to a network charging system.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a diagram of a wireless communication system according to some embodiments.

FIG. 2 is a block diagram of a network charging system according to some embodiments.

FIG. 3 is a block diagram of a message that may be used to convey charging information over a charging interface between base stations according to some embodiments.

FIG. 4 is a block diagram of a wireless communication system including an LTE base station and a Wi-Fi access point that communicate over a charging interface according to some embodiments.

FIG. 5 is a flow diagram of a method for collecting charging information and base stations that operate according to different RATs and conveying the charging information to a network charging system according to some embodiments.

FIG. 6 is a block diagram of a communication system according to some embodiments.

### DETAILED DESCRIPTION

Handing off user equipment between licensed and unlicensed frequency bands that operate according to different radio access technologies (RATs) may improve the overall capacity of a wireless communication system, e.g., by relieving congestion in heavily loaded base stations or by taking advantage of frequency bands with the highest channel qualities. Handoffs may also be used to reduce user costs. For example, user equipment may be handed off from licensed or unlicensed frequency bands supported by a base station that operates according to Long Term Evolution (LTE) standards to an unlicensed frequency band supported by a Wi-Fi access point that operates according to 802.11 standards. The inter-RAT handoff may be used to perform load balancing, in response to channel quality changes, or to take advantage of lower access costs associated with the Wi-Fi access point. However, devices such as Wi-Fi access points are not typically interconnected with the charging infrastructure of the wireless communication system because Wi-Fi access points are usually privately owned and users are not billed for data usage at the Wi-Fi access point. Consequently, service providers may find it difficult or impossible to acquire charging information for user equipment that have been handed off to a Wi-Fi access point.

Charging information for a call session that is handed over between a base station and an access point that operate according to different radio access technologies can be provided to the charging infrastructure of a wireless communication system using a charging interface established between the base station and the access point. The base station and the access point may be implemented in the same physical device or they may be implemented in co-located physical devices. The charging interface may therefore be an internal interface in a single physical device or an interface capable of conveying information between co-located physical devices. Charging information may include application layer information indicating a time count, volume count, a channel, a band, service type, data type, handover ID, sequence numbers, charging correlation information, and the like. The charging information is associated with a call session identifier that is used to correlate the charging information acquired by the base station and the access point during the call session. Thus, charges incurred by the user equipment during the call session can be billed to the user equipment even though the call session may be handed off between the base station and the access point. For example, the base station may provide the call session identifier to the access point as part of the handoff process from the base station to the access point. The access point generates a data usage report that includes the call session identifier and returns the data usage report to the base station over the charging interface. The base station can generate a consolidated data usage report for the call session and provide the consolidated data usage report to the charging infrastructure for billing and charging.

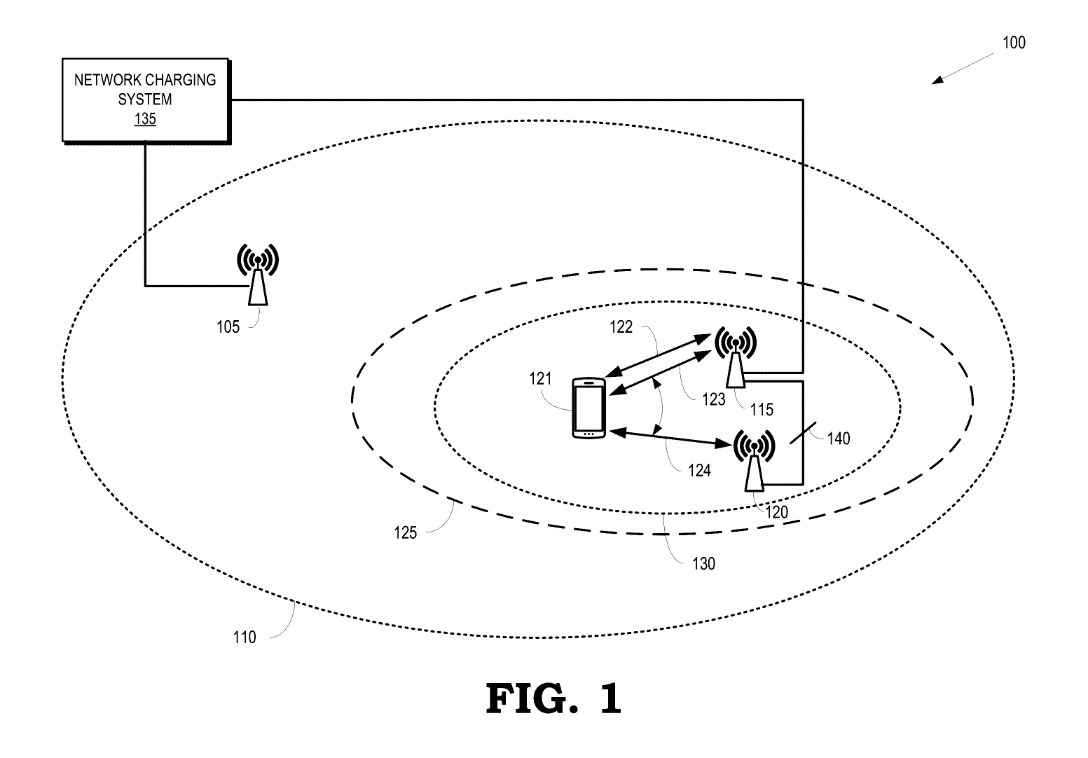

FIG. 1 is a diagram of a wireless communication system 100 according to some embodiments. The wireless communication system 100 includes one or more eNodeBs 105 that provide wireless connectivity according to a first radio access technology, e.g., according to the LTE standards defined by the Third Generation Partnership Project (3GPP). The eNodeB 105 provides wireless connectivity within a first geographical area or cell 110. The wireless communication system 100 also includes one or more small cells 115 that provide wireless connectivity according to the first radio access technology and one or more access points 120 that provide wireless connectivity according to a second radio access technology such as Wi-Fi, as defined by the IEEE 802 standards. As used herein, the term “base station” may be used to indicate eNodeBs that are part of a macrocellular network, as well as access points or small cells that overlay the macrocellular network. Small cells may also be referred to as home base station routers, metrocells, microcells, picocells, femtocells, and the like.

The small cell 115 may provide uplink or downlink communications to user equipment 121 over one or more carriers 122 in a licensed frequency band within the cell indicated by the dashed oval 125. The licensed carriers 122 operate according to the first RAT and may be referred to as LTE licensed (LTE-L) carriers. The small cell 115 may also support wireless connectivity over carriers 123 in one or more unlicensed frequency bands within a cell indicated by the dashed oval 130. The unlicensed carriers 123 may be referred to as LTE unlicensed (LTE-U) carriers. The unlicensed frequency bands may include the Unlicensed National Information Infrastructure (UNII), which is formed of portions of the radio spectrum that include frequency bands in the range of 5.15 GHz to 5.825 GHz such as the U-NII-1 band in the range 5.15-5.25 GHz, the U-NII 2a, b, c bands in the range 5.25-5.725 GHz, and the U-NII 3 band in the range 5.725-5.825 GHz. In some embodiments, the transmission power used by the small cell 115 to transmit signals in the licensed frequency band is larger than the transmission power used by the small cell 115 to transmit signals in the unlicensed frequency band. Consequently, the cell 125 is larger than the cell 130 in FIG. 1.

The small cell 115 may operate one or more of the unlicensed carriers 123 in different operating modes. For example, the small cell 115 may implement a supplemental downlink carrier in the unlicensed frequency band. The supplemental downlink carrier is used to carry best effort downlink data from the small cell 115 to the user equipment 121. A primary carrier is anchored in the licensed frequency band and is used to carry control data for the supplemental downlink carrier, as well as uplink data from the user equipment 121 to the small cell 115. For another example, the small cell 115 may implement a carrier aggregation mode in which a secondary carrier in the unlicensed frequency band carries both uplink and downlink best effort data. A primary carrier is anchored in the licensed frequency band and is used to carry control data for the secondary carrier.

The access point 120 supports wireless connectivity over unlicensed carriers 124 according to the second radio access technology and may therefore be referred to as a Wi-Fi access point 120. In the illustrated embodiment, the geographic area served by the access point 120 corresponds to the cell 130. However, some embodiments of the small cell 115 and the access point 120 may provide wireless connectivity within different sized cells. For example, the transmission powers used by the small cell 115 and the access point 120 may differ, leading to different sized cells. The access point 120 may be implemented according to conventional Wi-Fi or carrier-grade Wi-Fi, which supports additional functionality such as user authentication, mobility management, and the like. The access point 120 is co-located with the small cell 115. Thus, the access point 120 may be integrated into the same physical device as the small cell 115 or in a different physical device that is deployed near the small cell 115.

The user equipment 121 may establish call sessions with either the small cell 115 or the access point 120. The user equipment 121 may also hand off an existing call session between the small cell 115 and the access point 120. For example, the user equipment 121 may establish a call session with the small cell 115. The call session may subsequently be handed over to the access point 120 based on handover criteria associated with the user equipment 121. Examples of handover criteria include criteria include, but are not limited to, a priority and weight associated with the access point 120, a smart pricing policy, a cost incentive for using the access point 120, content service from the access point 120, the signaling strength of the access point 120, traffic load of on the access point 120, signal-to-noise level of the access point 120, a speed of the user equipment 121, security, energy efficiency based on proximity to the access point 120, and ownership of the access point 120. The handover criteria may be compared to corresponding handover criteria for the small cell 115 to determine whether to hand over the call session according to conventional practice. A unique call session identifier is assigned to the call session so that the call session can be identified before, during, and after handover between the small cell 115 and the access point 120.

The small cell 115 is connected to a network charging system 135, but the access point 120 does not have a direct connection to the network charging system 135. A charging interface 140 is therefore established between the small cell 115 and the access point 120. As discussed herein, the small cell 115 and the access point 120 may be co-located and consequently the charging interface 140 may be an internal interface in a single physical device or an interface capable of conveying information between co-located physical devices. The charging interface 140 may be implemented by modifying an X2 interface (as defined by 3GPP standards) or by defining a new interface. The small cell 115 may use the interface 140 to gather or aggregate charging information for call sessions that have been handed off to the access point 120. Some embodiments of the charging information include, but are not limited to, application layer information indicating a time count, volume count, a channel that transmits the data, a frequency band that transmits the data, service type, data type, handover ID, sequence numbers, charging correlation information, and the like.

Charging information collected by the small cell 115 and the access point 120 for the same call session may be correlated with each other using the unique call session identifier. The call session identifier is therefore transmitted over the interface 140 in response to handover of the call session between the small cell 115 and the access point 120 so that both entities can identify a charging session associated with the call session using the call session identifier. For example, the small cell 115 may use the call session identifier to forward charging information received from the access point 120 to the network charging system 135 so that the user is billed appropriately for data usage associated with the call session, regardless of whether the data usage occurred while the call session was associated with the small cell 115 or the access point 120. For another example, the small cell 115 may use the call session identifier to aggregate charging information collected by the small cell 115 with charging information collected by the access point 120 prior to sending a data usage report indicative of the aggregated charging information to the network charging system 135.

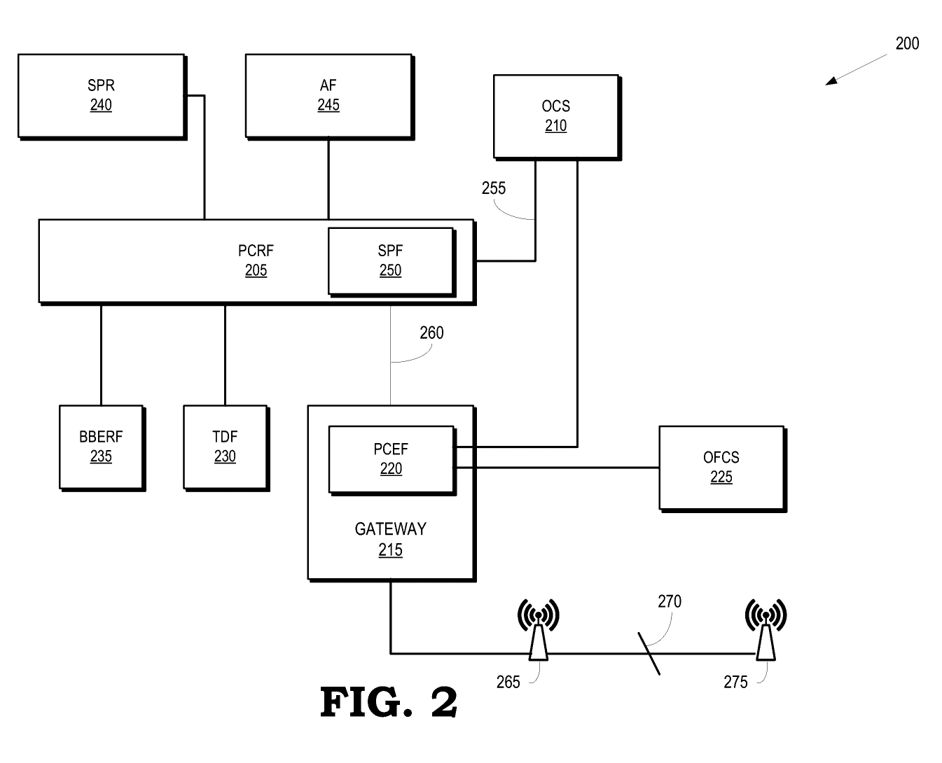

FIG. 2 is a block diagram of a network charging system 200 according to some embodiments. The network charging system 200 may be used to implement some embodiments of the network charging system 135 shown in FIG. 1. The network charging system 200 is used to determine a charge or an amount of money that is billed to an end-user. The architecture of the network charging system 200 may be defined according to the policy and charging control reference architecture defined by 3GPP TS 23.203, “Technical Specification Group Services and System Aspects, Policy and charging control architecture.” However, other embodiments of the network charging system 200 may be defined according to other reference architectures.

The network charging system 200 includes a policy control and charging rules function (PCRF) 205 that performs policy control decision-making and flow based charging control. An online charging system (OCS) 210 can provide data usage tariffs or policies to the PCRF 205 to indicate the data usage tariffs for licensed and unlicensed frequency bands such as LTE-L, LTE-U, and Wi-Fi. For example, the OCS 210 may generate data usage tariffs based on information collected by base stations or access points, as discussed herein. The OCS 210 may provide the information in either a push mode (e.g., without a specific request from the PCRF 205) or a pull mode (e.g., in response to a request from the PCRF 205). The charging policies may be determined based on a subscriber's charging account or an account associated with a group of subscribers. The data usage tariff for the unlicensed frequency band may be much lower than the data usage tariff for the licensed frequency band. However, some embodiments of the OCS 210 may determine the data usage tariffs based on other factors such as network traffic, location of the user equipment, quality of service, ownership of a base station, and the like. Thus, the data usage tariff for the unlicensed frequency band may in some cases be higher than the data usage tariff for the licensed frequency band.

The network charging system 200 also includes a gateway 215 such as a serving gateway (SGW) or a mobility management entity (MME) that is connected to the PCRF 205. The gateway 215 may be used to support communication between the network charging system 200 and base stations, eNodeBs, small cells, and the like. The gateway 215 includes a policy and charging enforcement function (PCEF) 220 that performs dataflow detection, policy enforcement, and flow-based charging. The OCS 210 may be connected to the PCEF 220 to provide policy information used by the PCEF 220. An off-line charging system (OFCS) 225 is also included in the network charging system 200 and is connected to the PCEF 220 to provide policies for off-line charging.

A traffic detection function (TDF) 230 performs application detection and reporting of detected applications. The TDF 230 also provides service data flow descriptors to the PCRF 205. A bearer binding and event reporting function (BBERF) 235 is used to perform bearer binding and binding verification, as well as providing event reporting to the PCRF 205. A subscription profile repository (SPR) 240 contains all subscriber/subscription related information needed for subscription-based policies. The SPR 240 also stores information indicating IP-CAN bearer level rules used by the PCRF 205. An application function (AF) 245 offers applications that may require dynamic policy or charging control. The AF 245 can communicate with the PCRF 205 to transfer dynamic session information to the PCRF 205.

Some embodiments of the PCRF 205 include a smart pricing function (SPF) 250 that is configured to generate charging policies and provide the charging policies to base stations such as the small cell 115 shown in FIG. 1. The PCRF 205 may generate the charging policies based on conditions in the base station such as conditions that may be detected by the TDF 230. The PCRF 205 may provide the charging policies to the base station in response to a request from a user equipment to establish a call session. For example, the gateway 215 may provide a request to the SPF 250 indicating that a user equipment has requested establishment of the call session. In response, the SPF requests data usage tariffs and other charging or policy information for the requested call session from the OCS 210, which provides the requested tariffs or charging/policy information over an interface 255 such as an Sy interface. The SPF 250 may then generate policies that govern the selective allocation of licensed and unlicensed frequency bands to the user equipment for the call session based on the information provided by the OCS 210, as well as other information that may be provided by other entities in the network charging system 200. Some embodiments of the PCRF 205 and the SPF 250 may proactively (e.g., without a specific request from the user equipment) request charging/policy information from the OCS 210 for user equipment and generate policies for the user equipment.

Some embodiments of the PCRF 205 may provide the charging policies to the gateway 215 over an interface 260 such as a Gx interface. The gateway 215 may then forward the charging policies to a base station (such as the eNodeB 105 shown in FIG. 1) for transmission to the base station. The gateway 215 may also provide the charging policies directly to the base station in some embodiments. The PCRF 205 may statically configure the base stations based on information provided by the service providers or the base stations may be dynamically configured, e.g. in response to changes in data service criteria as discussed below.

One or more small cells 265 may be coupled to the gateway 215 to provide charging information associated with call sessions established on the small cell 265. The small cell 265 also supports an interface 270 with an access point 275. Some embodiments of the small cell 265, the interface 270, and the access point 275 may be used to implement the small cell 115, the interface 140, and the access point 120 shown in FIG. 1. As discussed herein, the interface 270 may be used to convey charging information between the small cell 265 and the access point 275 so that the small cell 265 can collect or aggregate charging information associated with a call session that is handed off between the small cell 265 and the access point 275. The small cell 265 may then provide the charging information collected by the small cell 265 or the access point 275 to the gateway 215 so that the charging information can be used to bill the user for data usage associated with the small cell 265 or the access point 275.

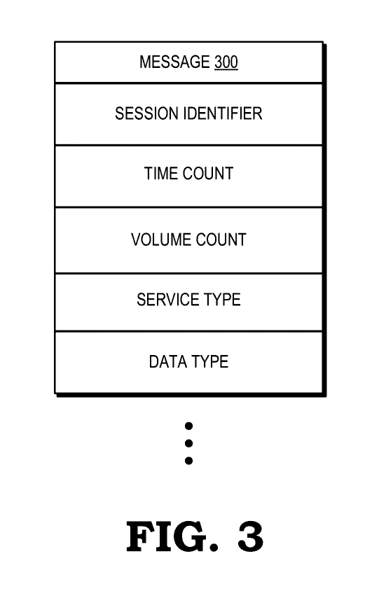

FIG. 3 is a block diagram of a message 300 that may be used to convey charging information over a charging interface between base stations according to some embodiments. The message 300 may be used to convey charging information collected by the access point 120 to the small cell 115 over the interface 140 shown in FIG. 1. The message 300 includes a session identifier that uniquely identifies the call session before, during, and after handover between the base stations that are connected by the charging interface. The charging information included in the message 300 may therefore be correlated with charging information collected by other base stations for the same call session. The message 300 includes additional fields for charging information including a time count, a volume count, a service type, and a data type associated with data usage in the base station that collected the charging information. However, some embodiments of the message 300 may include more or fewer fields for conveying more or fewer types of charging information.

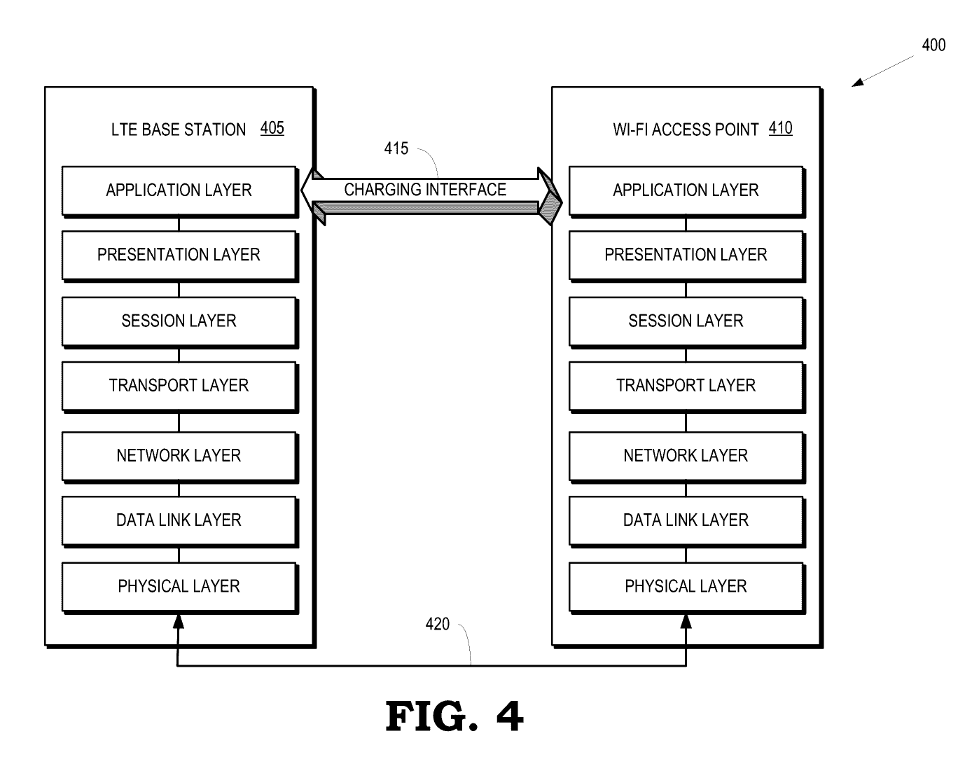

FIG. 4 is a block diagram of a wireless communication system 400 including an LTE base station 405 and a Wi-Fi access point 410 that communicate over a charging interface 415 according to some embodiments. The LTE base station 405, the Wi-Fi access point 410, and the charging interface 415 may be used to implement some embodiments of the small cell 115, the access point 120, and the interface 140 shown in FIG. 1.

Functional components in the LTE base station 405 and the Wi-Fi access point 410 are represented as different layers. Some embodiments of the layers may be defined according to the Open System Interconnection (OSI) model. For example, the application layer interacts with software applications and may be used to identify communication partners, determine resource availability, and synchronize communication. The presentation layer establishes a context between application layer entities in the LTE base station 405 and the Wi-Fi access point 410. The session layer establishes, manages, and terminates connections between applications in the LTE base station 405 and the Wi-Fi access point 410. The transport layer provides the functional and procedural means for transferring variable-length data sequences from a source to a destination, e.g., from the LTE base station 405 to the Wi-Fi access point 410 or vice versa. The network layer provides functional and procedural means of transferring the variable-length data sequences from one node to another connected to the same network, e.g., using logical network addresses for the LTE base station 405 and the Wi-Fi access point 410. The data link layer supports note-to-node data transfer and may also perform error correction. The physical layer defines the electrical and physical specifications of the data connection 415 between the LTE base station 405 and the Wi-Fi access point 410. The physical layer also defines a protocol to establish and terminate the physical connection 415.

The charging interface 415 is used to convey application layer charging information between the application layers in the LTE base station 405 and the Wi-Fi access point 410. The charging interface 415 may therefore be implemented using headers, encapsulation, tunneling, compression, and partitioning, packetizing, or other techniques as necessary to convert the application layer charging information into a format suitable for transmission over the physical connection 415. Some embodiments of the charging interface 415 transmit the charging information in the form of messages such as the message 300 shown in FIG. 3. Messages including charging information may be sent over the charging interface 415 in real time as they are received, periodically, at predetermined time intervals, in response to events such as handovers, in response to requests for charging information, in response to values of the charging information exceeding threshold values, or based on other criteria.

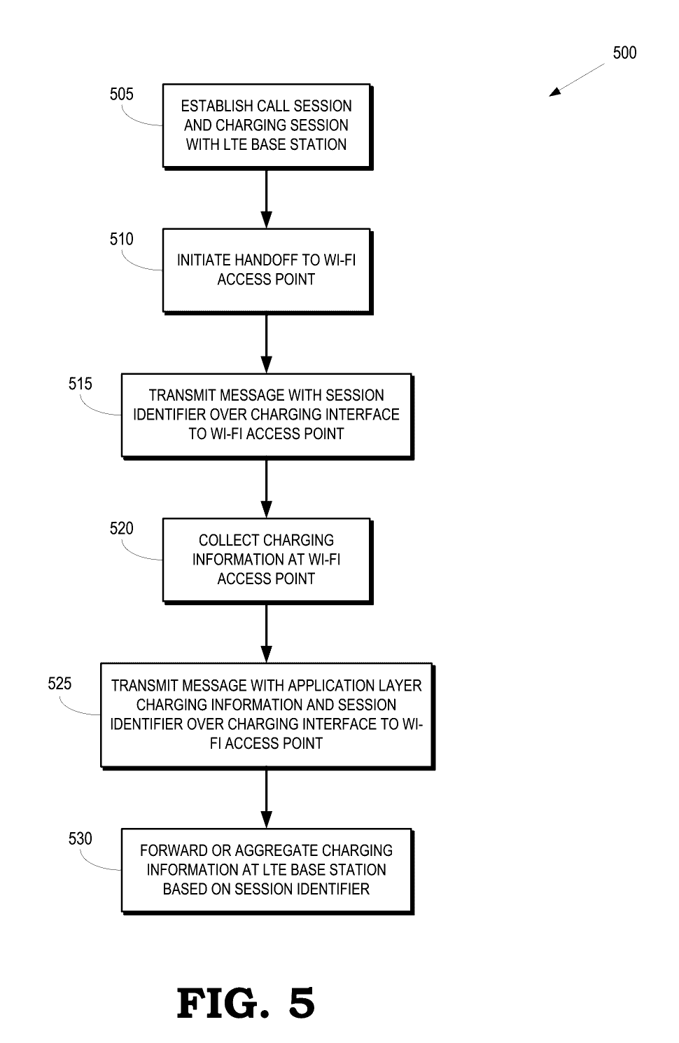

FIG. 5 is a flow diagram of a method 500 for collecting charging information at base stations that operate according to different RATs and conveying the charging information to a network charging system according to some embodiments. The method 500 may be implemented in some embodiments of the wireless communication system 100 shown in FIG. 1, the network charging system 200 shown in FIG. 2, or the wireless communication system 400 shown in FIG. 4. The embodiment of the method 500 illustrates the transfer of charging information in response to handover from an LTE base station to a Wi-Fi access point. However, other embodiments of the method 500 can be used to transfer charging information in response to handover from a Wi-Fi access point to an LTE base station, with appropriate modifications, or between base stations that operate according to other RATs. The LTE base station and the Wi-Fi access point communicate over a charging interface, as discussed herein.

At block 505, user equipment establishes a call session and a corresponding charging session with an LTE base station. At block 510, hand off of the user equipment and the associated call session from the LTE base station to the Wi-Fi access point is initiated. As discussed herein, hand off may be triggered based on hand off criteria including a priority and weight associated with the LTE base station or the Wi-Fi access point, a smart pricing policy, a cost incentive for using the Wi-Fi access point, content service from the Wi-Fi access point, the signaling strength of the LTE base station or the Wi-Fi access point, traffic load of on the LTE base station or the Wi-Fi access point, signal-to-noise level of the LTE base station or the Wi-Fi access point, a speed of the user equipment, security, energy efficiency based on proximity to the LTE base station or the Wi-Fi access point, and ownership of the LTE base station or the Wi-Fi access point.

At block 515, the LTE base station transmits a message over the charging interface to the Wi-Fi access point. The message includes a call session identifier to identify the call session to the Wi-Fi access point so that charging information collected by the Wi-Fi access point can be associated with the call session, e.g., for billing purposes. At block 520, the Wi-Fi access point collects charging information for data usage associated with the call session. The Wi-Fi access point may then generate information representative of the collected charging information and form a message including the information and the call session identifier. At block 525, the Wi-Fi access point transmits the message including the application layer charging information and the charging session identifier over the charging interface to the LTE base station.

At block 530, the LTE base station receives the message including the application layer charging information and the call session identifier over the interface. The LTE base station may then transmit the application layer charging information and the call session identifier to a network charging system so that a user can be billed for the data usage at the Wi-Fi access point. For example, the LTE base station may forward the application layer charging information and the call session identifier to the network charging system in real-time, e.g., as soon as this information is received at the LTE base station. Some embodiments of the LTE base station aggregate the application layer charging information from one or more messages received from the Wi-Fi access point before transmitting the aggregated information to the network charging system. Aggregation may be performed for messages received in predetermined time intervals, in response to events such as handover of the user equipment from the Wi-Fi access point back to the LTE base station or to another entity, in response to requests for charging information, in response to values of the charging information exceeding threshold values, or based on other criteria.

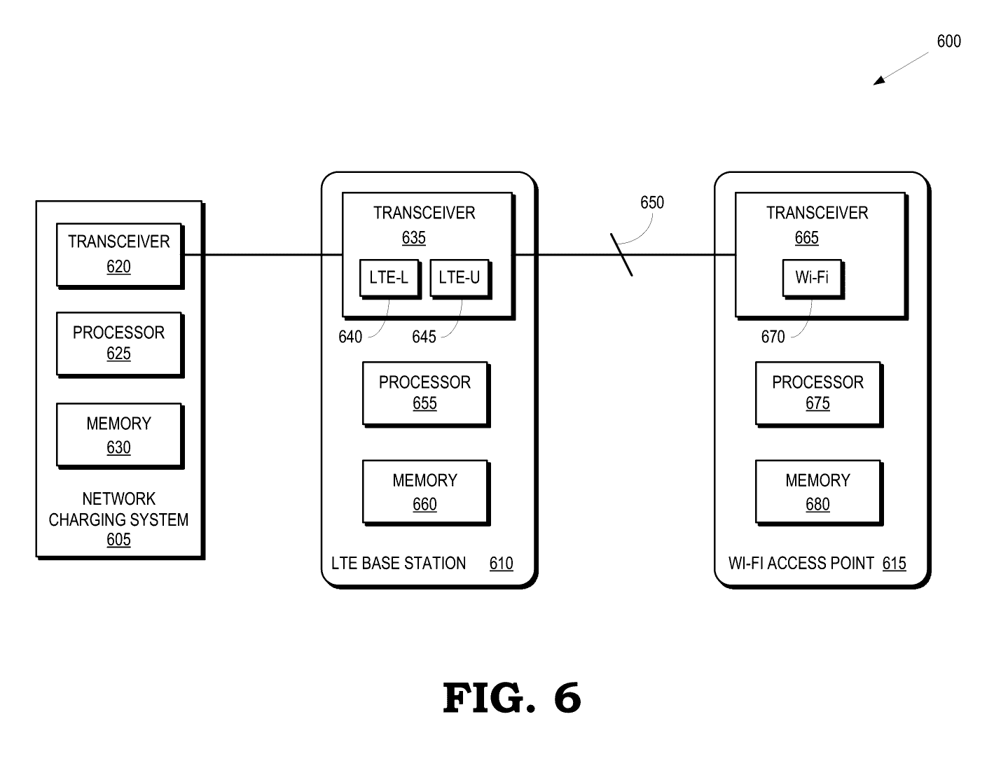

FIG. 6 is a block diagram of a communication system 600 according to some embodiments. The communication system 600 includes a network charging system 605, an LTE base station 610, and a Wi-Fi access point 615. Some embodiments of the network charging system 605, the LTE base station 610, and the Wi-Fi access point 615 may be used to implement the network charging system 135, the small cell 115, and the access point 120 shown in FIG. 1 or the network charging system 200 shown in FIG. 2, as well as other entities described herein.

The network charging system 605 includes a transceiver 620 for transmitting and receiving signals. For example, the network charging system 605 may generate charging policies and provide them to the LTE base station 610, which may provide the network charging system 605 with charging information collected by the LTE base station 610 or the Wi-Fi access point 615, as discussed herein. The network charging system 605 also includes a processor 625 and a memory 630. The processor 625 may be used to execute instructions stored in the memory 630 and to store information in the memory 630 such as the results of the executed instructions or the charging information provided by the LTE base station 610.

The LTE base station 610 includes a transceiver 635 for transmitting and receiving signals. Some embodiments of the transceiver 635 include multiple radios for communicating according to different radio access technologies such as a radio 640 for communication in licensed LTE frequency bands (LTE-L) and a radio 645 for communication in unlicensed LTE frequency bands (LTE-U). For example, the LTE-L radio 640 may be used to communicate with user equipment in the licensed frequency band and the LTE-U radio 645 may be used to communicate with user equipment in the unlicensed frequency band. The transceiver 635 may be used to transmit charging information collected by the LTE base station 610 or the Wi-Fi access point 615 (and the associated call session identifier) to the network charging system 605. The transceiver 635 may further be used to transmit or receive messages over a charging interface 650 with the Wi-Fi access point 615, as discussed herein. The LTE base station 610 also includes a processor 655 and a memory 660. The processor 655 may be used to execute instructions stored in the memory 660 and to store information in the memory 660 such as the results of the executed instructions or charging information collected by the LTE base station 610 or the Wi-Fi access point 615. Some embodiments of the processor 655 and the memory 660 may be configured to perform portions of the method 500 shown in FIG. 5.

The Wi-Fi access point 615 includes a transceiver 665 for transmitting and receiving signals. Some embodiments of the Wi-Fi access point 615 implement a radio 670 for Wi-Fi communication in unlicensed frequency bands. The transceiver 665 may be used to transmit charging information collected by the Wi-Fi access point 615 and the associated call session identifier to the LTE base station 610 over the charging interface 650, as discussed herein. The Wi-Fi access point 615 also includes a processor 675 and a memory 680. The processor 675 may be used to execute instructions stored in the memory 680 and to store information in the memory 680 such as the results of the executed instructions or charging information collected by the Wi-Fi access point 615. Some embodiments of the processor 675 and the memory 680 may be configured to perform portions of the method 500 shown in FIG. 5.

In some embodiments, certain aspects of the techniques described above may implemented by one or more processors of a processing system executing software. The software comprises one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

A computer readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc , magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A method comprising:
transmitting an identifier over an interface between a first base station and a second base station in response to initiation of a handover of a call session between the first and second base stations, wherein the first and second base stations operate according to different radio access technologies; and
transmitting, from the first base station to a network charging system, first charging information collected by the first base station for the call session and second charging information collected by the second base station for the call session, wherein the first and second charging information are associated with the identifier.

2. The method of claim 1, further comprising:
collecting, at the first and second base stations, respectively, the first and second charging information.

3. The method of claim 2, wherein collecting the first and second charging information comprises collecting first and second application layer charging information.

4. The method of claim 3, wherein collecting the first and second application layer charging information comprises collecting information indicative of at least one of a group consisting of a time count, a volume count, a channel, a frequency band, a service type, a data type, a handover identifier, a sequence number, and charging correlation information.

5. The method of claim 2, further comprising:
transmitting, from the second base station over the interface, the identifier and the second charging information; and
receiving, at the first base station over the interface, the identifier and the second charging information.

6. The method of claim 1, further comprising:
aggregating, at the first base station, the first and second charging information before providing the aggregated charging information to the network charging system.

7. A method comprising:
receiving, at a first base station in response to initiation of a handover of a call session between the first base station and a second base station, an identifier and second charging information collected by the second base station for the call session, wherein the identifier and the second charging information are received over an interface between the first and second base stations, and wherein the first and second base stations operate according to different radio access technologies; and
transmitting, from the first base station to a network charging system, first charging information collected by the first base station for the call session and the second charging information using the identifier.

8. The method of claim 7, further comprising:
establishing the call session at the first base station;
handing over the call session from the first base station to the second base station; and
providing the identifier to the second base station to identify a charging session associated with the call session.

9. The method of claim 8, wherein receiving the identifier and the second charging information comprises receiving the identifier and the second charging information in response to handing over the call session from the first base station to the second base station.

10. The method of claim 7, further comprising:
handing over the call session from the second base station to the first base station, and wherein receiving the identifier and the second charging information comprises receiving the identifier and the second charging information in response to handing over the call session from the second base station to the first base station.

11. The method of claim 7, further comprising:
collecting, at the first base station, the first charging information.

12. The method of claim 11, wherein collecting the first charging information comprises collecting first application layer charging information, and wherein receiving the second charging information comprises receiving second application layer charging information.

13. The method of claim 12, wherein collecting the first application layer charging information comprises collecting first information indicative of at least one of a group consisting of a time count, a volume count, a channel, a frequency band, a service type, a data type, a handover identifier, a sequence number, and charging correlation information, and wherein receiving the second application layer charging information comprises receiving second information indicative of at least one of the group consisting of the time count, the volume count, the channel, the frequency band, the service type, the data type, the handover identifier, the sequence number, and the charging correlation information.

14. The method of claim 7, further comprising:
aggregating, at the first base station, the first and second charging information before transmitting the aggregated charging information to the network charging system.

15. A method comprising:
collecting, at a first base station, first charging information for a call session; and
transmitting, from the first base station over an interface between the first base station and a second base station, an identifier and the first charging information in response to initiation of a handover of the call session between the first and second base stations, wherein the first and second base stations operate according to different radio access technologies, and wherein the identifier is used to associate the first charging information with second charging information collected by the second base station for the call session.

16. The method of claim 15, further comprising:
handing over the call session from the second base station to the first base station; and
receiving, at the first base station, the identifier to identify a charging session associated with the call session.

17. The method of claim 16, wherein collecting the first charging information comprises collecting the first charging information in response to handing over the call session from the second base station to the first base station.

18. The method of claim 15, further comprising:
handing over the call session from the first base station to the second base station, and wherein transmitting the identifier and the second charging information comprises transmitting the identifier and the second charging information in response to handing over the call session from the first base station to the second base station.

19. The method of claim 15, wherein collecting the first charging information comprises collecting first application layer charging information, and wherein receiving the second charging information comprises receiving second application layer charging information.

20. The method of claim 19, wherein collecting the first application layer charging information comprises collecting first information indicative of at least one of a group consisting of a time count, a volume count, a channel, a frequency band, a service type, a data type, a handover identifier, a sequence number, and charging correlation information, and wherein receiving the second application layer charging information comprises receiving second information indicative of at least one of the group consisting of the time count, the volume count, the channel, the frequency band, the service type, the data type, the handover identifier, the sequence number, and the charging correlation information.
